(19) United States
(12) Patent Application Publication
(10) Pub. No.: US 2007/0264442 A1
(43) Pub. Date: Nov. 15, 2007

(54) Method for making bio-degradable paper board

(76) Inventor: Hsi-Ching Chang, Changhua (TW)

Correspondence Address: Hsi-Ching Chang, P.O. BOX 215, TAICHUNG, 40099, TW

(21) Appl. No.: 11/878,017

(22) Filed: Jul. 20, 2007

Related U.S. Application Data
(63) Continuation-in-part of application No. 11/171,426, filed on Jul. 1, 2005.

(51) Int. Cl. H05H 1/00

(52) U.S. Cl. 427/538

(57) ABSTRACT

A method for making the bio-degradable paper board includes a step of pre-heating and the paper roll and removing static electricity from the paper roll by way of corona treatment; a step of pre-heating the bio-degradable material to be liquid status; a step of extruding the bio-degradable material to be foam type layer and coating the foam type layer on the paper roll; a step of cooling the foam type layer by cooling rollers which evenly press the layer on the paper board; a step of cooling the layer on the paper board by cooling rollers and treated by another corona treatment, and a step of cutting the paper board into desired sections.

### FIELD OF THE INVENTION

This is a Continuation In Part application of applicant's former patent application with application No. 11/171,426 filed on Jul. 1, 2005.

### BACKGROUND OF THE INVENTION

A conventional food box made by paper material generally includes a paper board and a layer which is glued to the outside of the food box. The layer includes printed patters and does not contact the food. The layer is made by polyethylene (PE), polypropylene (PP), polyvinyl chloride (PVC) or corn starch. Only the corn starch is bio-degradable. The layer has to be made to have a certain thickness and patterns are printed on the layer before the layer is glued to the food box. An adhesive is located between the outside of the paper box and the layer. Besides, the layer is not directly connected to the food box, the layer might be peeled off if the adhesive is not applied evenly on the surface of the paper-made food box. Furthermore, the layer has to be made to have a certain thickness so that it includes a higher manufacturing cost. Most important is that PE, PP and PVC cannot be bio-degraded.

The present invention intends to provide a bio-degradable paper board which can be made into food boxes and includes a layer of PET or PLA which is coated on the paper board directly by extrusion-coating machine.

The present invention also provide a method for making paper boards that are suitable for being contact with food and can be made to be food containers for storage of food.

### SUMMARY OF THE INVENTION

The method for making the paper board of the present invention includes a step of pre-heating and the paper roll and removing static electricity from the paper roll by way of corona treatment; a step of pre-heating the bio-degradable material to be liquid status; a step of extruding the bio-degradable material to be foam type layer and coating the foam type layer on the paper roll; a step of cooling the foam type layer by cooling rollers which evenly press the layer on the paper board; a step of cooling the layer on the paper board by cooling rollers and treated by another corona treatment, and a step of cutting the paper board into desired sections.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows a paper roll of the present invention, and

FIG. 2 is a cross sectional view to show the bio-degradable layer on the paper board.

### DETAILED DESCRIPTION OF THE PREFERRED EMBODIMENT

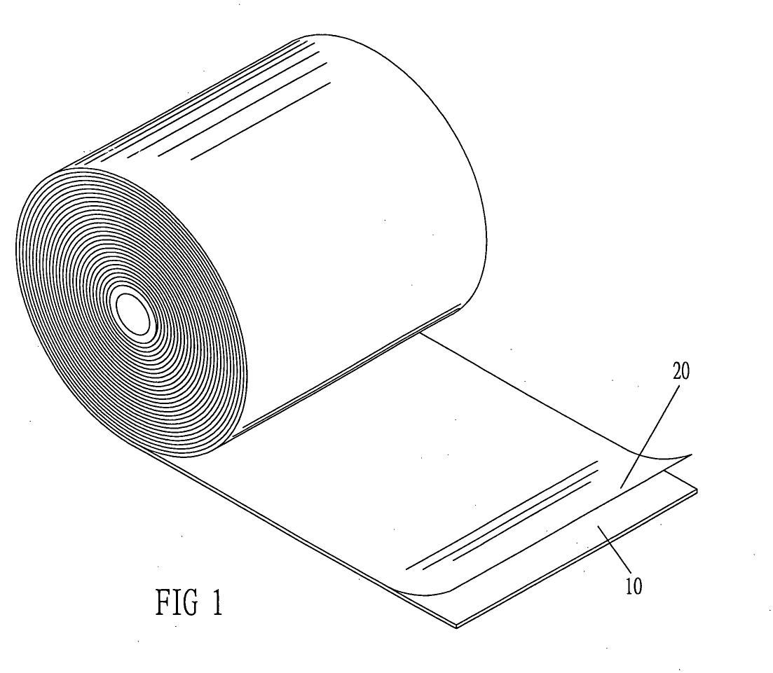

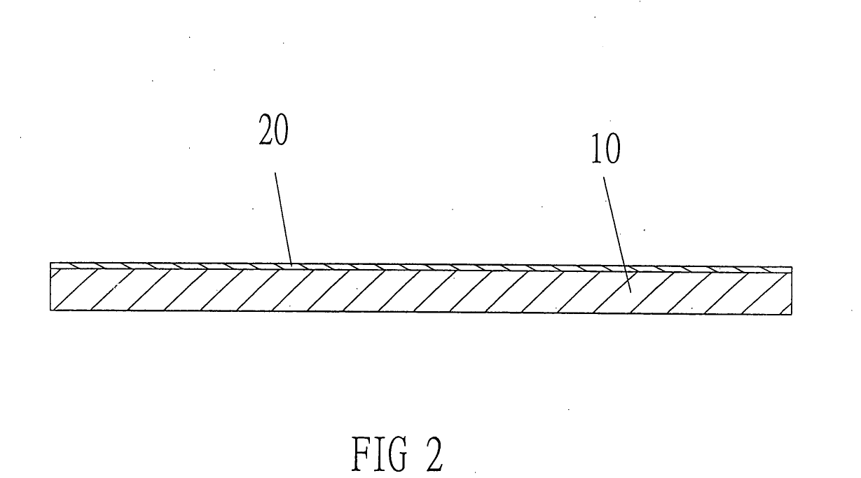

Referring to FIGS. 1 and 2, the paper board 10 of the present invention is in a form of a paper roll and a bio-degradable layer 20 is coated to the paper board 10 by extrusion-coating machine. The bio-degradable layer 20 is a layer of Polylactic Acid (PLA), Polyethylene Terephthalate (PET) or corn starch.

The bio-degradable layer 20 can be made from PET such as Biomax PET by Dupond, bio-degradable PET particles by Far-Eastern Textile Ltd (Taiwan), Polylactic Acid (PLA) particles by Nature works L.L.C., or corn starch. The material is heated to be liquid and extruded by an extruder. The liquid is extruded by T-Die to be foam-type bio-degradable layer 20. The paper board 10 is in a form of a paper roll which is pre-heated and then treated by corona treatment.

The foam type bio-degradable layer 20 is applied on the paper board 10 and both of which are fed between silicon rollers and cooling rollers to evenly press the bio-degradable layer 20 on the paper board 10. The material of the bio-degradable layer 20 is combined with fibers of the paper board 10. The pressed paper board 10 and the bio-degradable layer 20 are then treated by another corona treatment to open the orifices of the paper board 10. The paper board 10 is then can be cut and folded to be food containers.

There is no adhesive located between the bio-degradable layer 20 and the paper board 10 and the bio-degradable layer 20 does not need to be made to be a certain thickness so that the procedures are simplified and the manufacturing cost is reduced. The paper board 10 and the layer 20 are both biodegradable and the material of the bio-degradable layer 20 can be degraded into water and carbon dioxide within few months. The paper board 10 is sold in a form of paper roll which can be cut as desired.

The method for making the paper boards 10 includes the following steps:

Step 1: pre-heating and the paper roll and removing static electricity from the paper roll by way of corona treatment;

Step 2: pre-heating the bio-degradable material to be liquid status;

Step 3: extruding the biodegradable material to be foam type layer 20 and coating the foam type layer 20 on the paper roll which is stretched between silicon rollers to be paper board;

Step 4; cooling the foam type layer 20 by cooling rollers which evenly press the layer 20 on the paper board 10;

Step 5: cooling the layer 20 on the paper board 10 by cooling rollers and treated by another corona treatment, and

Step 6: cutting the paper board into desired sections.

The iron rollers are heated by providing hot water through pipes in the iron rollers and the hot water is supplied constantly to keep the iron rollers at desired temperature. One of the iron rollers is coated with TEFLON such that the foam type layer 20 does not stick on the rollers. The biodegradable layer 20 is crystallized when being in contact with air and is melted again when the paper board 10 is fed by the heated iron rollers so as to be combined with the fibers of the paper board 10.

While we have shown and described the embodiment in accordance with the present invention, it should be clear to those skilled in the art that further embodiments may be made without departing from the scope of the present invention.

What is claimed is:

1. A method for making bio-degradable paper board, comprising the following steps:
step 1: pre-heating and the paper roll and removing static electricity from the paper roll by way of corona treatment;
step 2: pre-heating the bio-degradable material to be liquid status;
step 3: extruding the bio-degradable material to be foam type layer and coating the foam type layer on the paper roll;
step 4; cooling the foam type layer by cooling rollers which evenly press the layer on the paper board;
step 5: cooling the layer 20 on the paper board 10 by cooling rollers and treated by another corona treatment, and
step 6: cutting the paper board into desired sections.

2. The method as claimed in claim 1, wherein the paper roll is stretched between silicon rollers to be paper board and the iron rollers are heated.

3. The method as claimed in claim 2, wherein the iron rollers are provided with hot water which flows through the iron rollers.
